(19) United States
(12) Patent Application Publication
(10) Pub. No.: US 2022/0310046 A1
(43) Pub. Date: Sep. 29, 2022

(54) METHODS, INFORMATION PROCESSING DEVICE, PERFORMANCE DATA DISPLAY SYSTEM, AND STORAGE MEDIA FOR ELECTRONIC MUSICAL INSTRUMENT

(71) Applicant: CASIO COMPUTER CO., LTD., Tokyo (JP)

(72) Inventors: Shigeru KAFUKU, Tokyo (JP); Hiroko OKUDA, Tokyo (JP); Masayuki HIROHAMA, Tokyo (JP)

(73) Assignee: CASIO COMPUTER CO., LTD., Tokyo (JP)

(21) Appl. No.: 17/700,692

(22) Filed: Mar. 22, 2022

(30) Foreign Application Priority Data
Mar. 24, 2021 (JP) 2021-050017

(51) Int. Cl. G10H 1/00

(52) U.S. Cl. CPC G10H 1/0008; G10H 2210/066; G10H 2210/091; G10H 2210/051; G10H 2220/005; G10H 2210/095

(57) ABSTRACT

A method performed by one or more processors in an information processing device for an electronic musical instrument includes, via the one or more processors: receiving performance data generated by a user performance of the electronic musical instrument; extracting time-series characteristics of a sequence of notes from the performance data; detecting a performance technique from the extracted characteristics; and generating an image data reflecting the detected performance technique and outputting the generated image data.

### BACKGROUND OF THE INVENTION

### Technical Field

The present disclosure relates to methods, information processing devices, performance data display systems, and recording media for electronic musical instruments.

### Background Art

Electronic musical instruments such as digital keyboards are equipped with a processor and a memory, and can be said to be an embedded computer with a keyboard. Models that can use various extended functions by connecting to an information processing device such as a tablet with an interface such as USB (Universal Serial Bus) are also known. For example, a technology has been developed that analyzes MIDI (Musical Instrument Digital Interface) data generated by the user playing an electronic musical instrument, and that creates and displays video images that change with the performance and still images (pictures) that reflect the content of the performance. (For example, see Patent Document 1: Japanese Patent Application Laid-Open No. 2019-101168).

Practicing musical instruments is difficult, and many people get bored and give up on the way. Recording the performer's performance and checking which part the performer couldn't play is a practice only possible after the performer can learn how to play the instrument to some extent, and many people give up before reaching that level. In order to motivate not only advanced players but also those who are standing at the entrance to playing musical instruments, attention is focused on technology that visualizes music performances and uses visual effects.

### SUMMARY OF THE INVENTION

Additional or separate features and advantages of the invention will be set forth in the descriptions that follow and in part will be apparent from the description, or may be learned by practice of the invention.

The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides a method performed by one or more processors in an information processing device for an electronic musical instrument, the method comprising, via the one or more processors: receiving performance data generated by a user performance of the electronic musical instrument; extracting time-series characteristics of a sequence of notes from the performance data; detecting a performance technique from the extracted characteristics; and generating an image data reflecting the detected performance technique and outputting the generated image data.

In another aspect, the present disclosure provides an information processing device for an electronic musical instrument, comprising: one or more processors, configured to perform the following: receiving performance data generated by a user performance of the electronic musical instrument; extracting time-series characteristics of a sequence of notes from the performance data; detecting a performance technique from the extracted characteristics; and generating an image data reflecting the detected performance technique and outputting the generated image data to an display device for display.

In another aspect, the present disclosure provides a performance data display system, comprising: the above-described information processing device; the above-described electronic musical instrument; and the above-described display device.

In another aspect, the present disclosure provides a non-transitory computer readable storage medium storing a software program to be read by one or more of processors in an information processing device for an electronic musical instrument, the software program causing the one or more processors to perform the following: receiving performance data generated by a user performance of the electronic musical instrument; extracting time-series characteristics of a sequence of notes from the performance data; detecting a performance technique from the extracted characteristics; and generating an image data reflecting the detected performance technique and outputting the generated image data.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is a schematic diagram showing an example of a performance data display system according to an embodiment.

FIG. 2 is a block diagram showing an example of the digital keyboard 1 according to the embodiment.

FIG. 3 is a functional block diagram showing an example of the information processing device 3.

FIG. 4 is a flowchart showing an example of the processing procedure of the information processing device 3.

FIG. 5 is a diagram showing one musical score example.

FIG. 6 is a diagram showing an example of a first image created from the musical score example of FIG. 5.

FIG. 7 is a diagram showing an example of a second image created from the musical score example of FIG. 5.

FIG. 8 is a flowchart showing an example of the processing procedure of the performance technique recognition process in step S3.

FIG. 9 is a diagram showing an example of setting which one is prioritized when a plurality of performance techniques are recognized.

FIG. 10 is a flowchart showing an example of the processing procedure in the glissando detection process.

FIG. 11 is a diagram showing an example of expression when glissando is detected.

FIG. 12 is a flowchart showing an example of the processing procedure in the legato detection process.

FIG. 13 is a diagram showing an example of image expression when legato is detected.

FIG. 14 is a flowchart showing an example of the processing procedure in the trill detection process.

FIG. 15 is a diagram showing an example of image expression when trill is detected.

FIG. 16 is a flowchart showing an example of the processing procedure in the velocity standout note detection process.

FIG. 17 is a diagram showing an example of image expression when a velocity standout note is detected.

### DETAILED DESCRIPTION OF EMBODIMENTS

Hereinafter, embodiments of the present disclosure will be described with reference to the drawings.

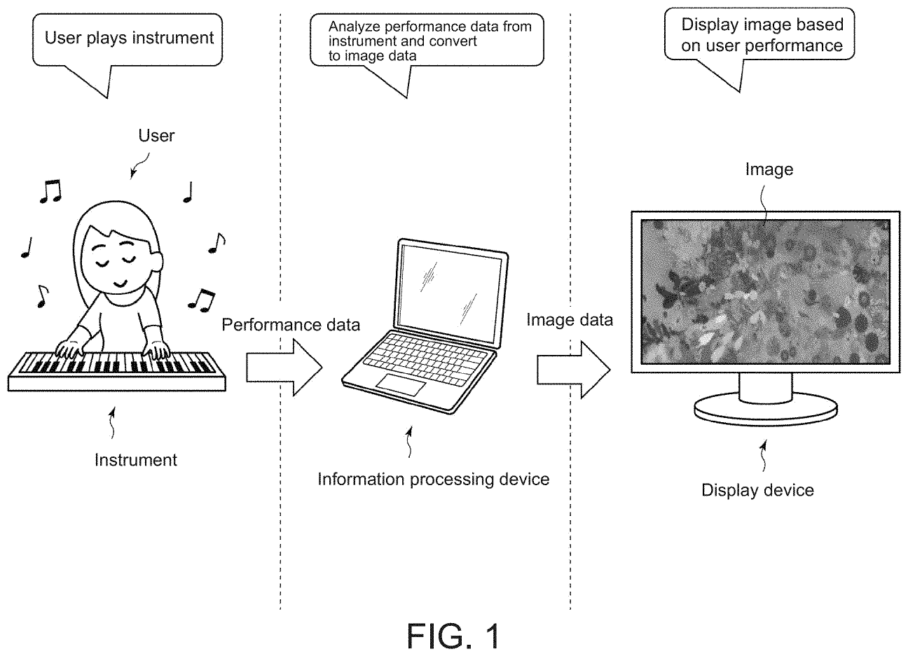

FIG. 1 is a schematic diagram showing an example of a performance data display system according to an embodiment. The performance data display system shown in FIG. 1 draws an image (picture) in real time according to the performance of the user (performer). This type of performance data display system analyzes performance data acquired from an electronic musical instrument or the like that can output the user's performance as performance data (for example, MIDI data), and generates an image based on the analysis result.

In FIG. 1, the performance data display system includes an electronic musical instrument, an information processing device, and a display device.

The electronic musical instrument generates performance data (for example, MIDI data) from the user's performance, and outputs the performance data to the information processing device. The information processing device analyzes the received performance data and generates image data. The information processing device is, for example, a tablet or a PC (personal computer). The display device displays an image generated by the information processing device.

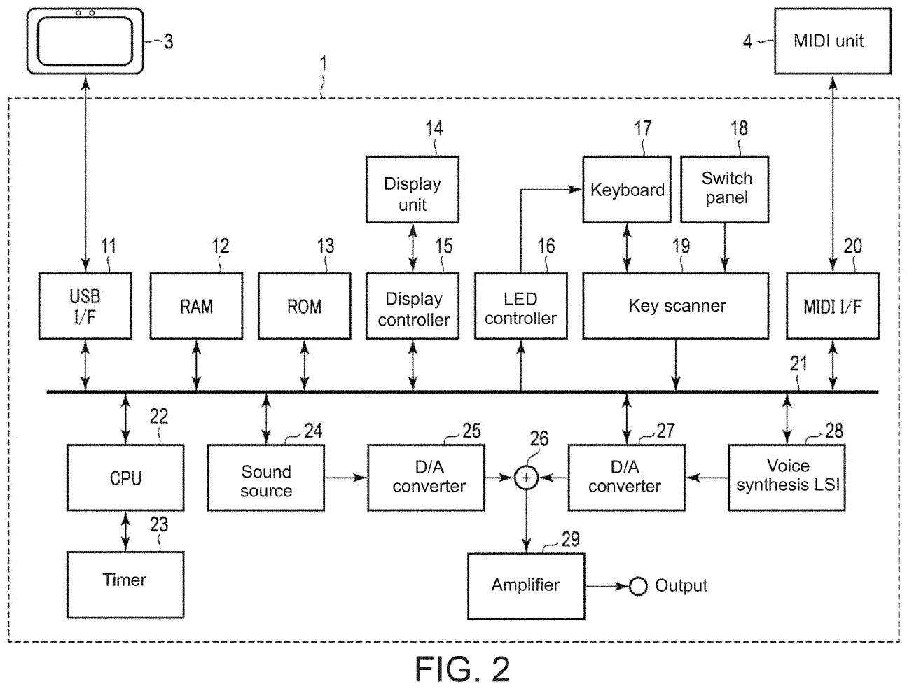

FIG. 2 is a block diagram showing an example of the digital keyboard 1 according to the embodiment. The digital keyboard 1 includes a USB interface (I/F) 11, a RAM (Random Access Memory) 12, a ROM (Read Only Memory) 13, a display unit 14, a display controller 15, an LED (Light Emitting Diode) controller 16, a keyboard 17, an operation unit (switch panel) 18, a key scanner 19, a MIDI interface (I/F) 20, a system bus 21, a CPU (Central Processing Unit) 22, a timer 23, a sound source 24, a digital/analog (D/A) converter 25, a mixer 26, a D/A converter 27, a voice synthesis LSI 28, and an amplifier 29. Here, the sound source 24 and the voice synthesis LSI 28 are realized as, for example, a DSP (Digital Signal Processor).

The CPU 22, the sound source 24, the voice synthesis LSI 28, the USB interface 11, the RAM 12, the ROM 13, the display controller 15, the LED controller 16, the key scanner 19, and the MIDI interface 20 are connected to the system bus 21.

The CPU 22 is a processor that controls the digital keyboard 1. That is, the CPU 22 reads the program stored in the ROM 13 into the RAM 12 as a working memory and executes it to realize various functions of the digital keyboard 1. The CPU 22 operates according to the clock supplied from the timer 23. The clock is used, for example, to control the sequences of automatic performance and automatic accompaniment.

The ROM 13 stores programs, various setting data, automatic accompaniment data, and the like. The automatic accompaniment data may include preset rhythm patterns, chord progressions, bass patterns, melody data such as obbligatos, and the like. The melody data may include pitch information of each note, sound production timing information of each note, and the like.

The sound production timing of each note may be specified by interval time between each sound generation, or by the elapsed time from the start of the song that is being automatically performed. Tick is often used as the unit of time. 1 Tick is a unit used in popular sequencers based on the tempo of a song. For example, if the resolution of the sequencer is 480, 1/480 of the quarter note time is 1 Tick.

The automatic accompaniment data may be stored in an information storage device or an information storage medium (not shown) other than the ROM 13. The format of the automatic accompaniment data may conform to the file format for MIDI.

The display controller 15 is an IC (Integrated Circuit) that controls the display state of the display unit 14. The LED controller 16 is, for example, an IC. The LED controller 16 illuminates the keys of the keyboard 17 according to instructions from the CPU 22 to navigate the performance of the performer.

The key scanner 19 constantly monitors the key press/release state of the keyboard 17 and the switch operation state of the operation unit 18. Then, the key scanner 19 conveys the states of the keyboard 17 and the operation unit 18 to the CPU 22.

The MIDI interface 20 receives a MIDI message (performance data or the like) from an external device such as the MIDI device 4, and outputs a MIDI message to the external device. The digital keyboard 1 can send and receive MIDI messages and MIDI data files to and from an external device using an interface such as USB (Universal Serial Bus). The received MIDI message is passed to the sound source 24 via the CPU 22. The sound source 24 generates a sound according to the tone color, volume (velocity), timing, etc., specified in the MIDI message.

The sound source 24 is, for example, a so-called GM sound source that conforms to the GM (General MIDI) standard. With this type of sound source, the tone color can be changed by giving a program change as a MIDI message, and the default effect can be controlled by giving a control change.

The sound source 24 has, for example, the ability to produce sounds of up to 256 voices at the same time. The sound source 24 reads, for example, musical sound waveform data from a waveform ROM (not shown) and outputs the digital musical sound waveform data to the D/A converter 25. The D/A converter 25 converts the digital musical sound waveform data into an analog musical sound waveform signal.

When the voice synthesis LSI 28 is given the text data of the lyrics and the information about the pitch as the singing voice data from the CPU 22, the voice data of the corresponding singing voice is synthesized and output to the D/A converter 27. The D/A converter 27 converts the voice data into an analog voice waveform signal.

The mixer 26 mixes the analog musical sound waveform signal and the analog voice waveform signal to generate an output signal. This output signal is amplified by the amplifier 29 and output from an output terminal such as a speaker or a headphone out.

The information processing device 3 is connected to the system bus 21 via the USB interface 11. The information processing device 3 can acquire MIDI data (performance data) generated by playing the digital keyboard 1 via the USB interface 11.

Further, a storage medium or the like (not shown) may be connected to the system bus 21 via the USB interface 11. Examples of the storage medium include a USB memory, a flexible disk drive (FDD), a hard disk drive (HDD), a CD-ROM drive, a magneto-optical disk (MO) drive, and the like. When the program is not stored in the ROM 106, the program may be stored in the storage medium and read into the RAM 105 so that the CPU 111 can execute the same operations as when the program is stored in the ROM 106.

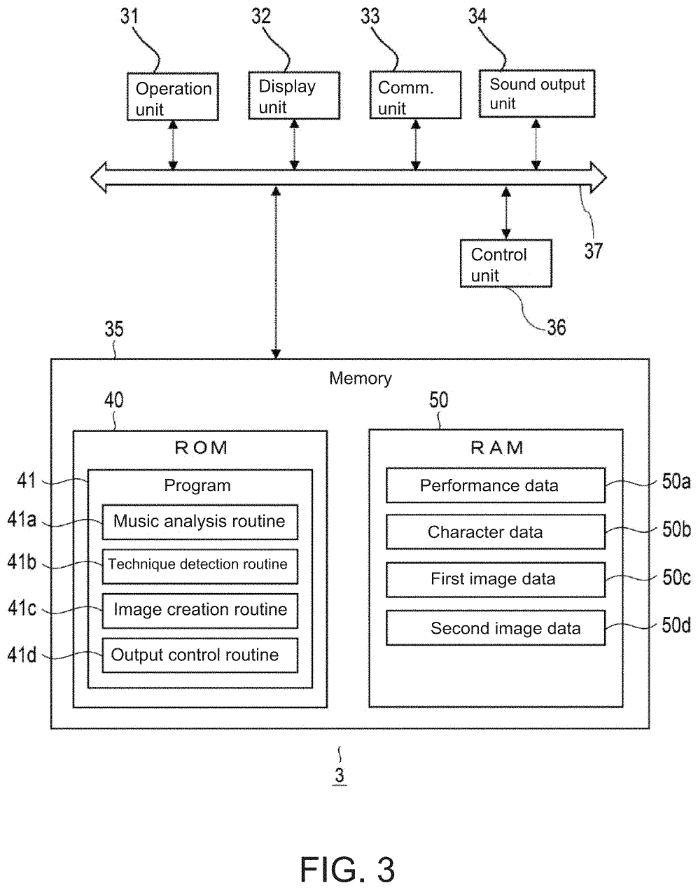

FIG. 3 is a functional block diagram showing an example of the information processing device 3. In FIG. 3, the information processing device 3 includes an operation unit 31, a display unit 32, a communication unit 33, a sound output unit 34, a control unit 36 (CPU), and a memory 35. The operation unit 31, display unit 32, communication unit 33, sound output unit 34, control unit 36, and memory 35 are communicably connected by a bus 37, and requisite data is exchanged between the units via the bus 37.

The operation unit 31 includes, for example, switches such as a power switch for turning on/off the power. The display unit 32 has a liquid crystal monitor with a touch panel and displays an image. Since the display unit 32 also has a touch panel function, it can perform a part of the functions of the operation unit 31.

The communication unit 33 includes a wireless unit and a wired unit for communicating with other devices and the like. In this embodiment, it is connected to the digital keyboard 1 by wire such as a USB cable, whereby the information processing device 3 can exchange various digital data with the digital keyboard 1.

The sound output unit 34 includes a speaker, an earphone jack, and the like, and outputs analog audio and music sounds and/or outputs an audio signal.

The control unit 36 includes a processor such as a CPU and controls the information processing device 3. The CPU of the control unit 36 executes various processes according to the control program stored in the memory 35 and the installed applications.

The memory 35 includes a ROM 40 and a RAM 50.

The ROM 40 stores, for example, a program 41 executed by the control unit 36, various data, tables, and the like.

The RAM 50 stores data necessary for executing the program 41. The RAM 50 also functions as temporary storage areas for data created by the control unit 36, MIDI data sent from the digital keyboard 1, data for launching an application, and the like. In this embodiment, the RAM 50 stores performance data 50a as MIDI data, character data 50b, first image data 50c, and second image data 50d, which are derived from performance data 50a.

The character data 50b is image data of familiar characters such as flowers, insects, animals, and ribbons, for example. Depending on the musical harmony of the performance, a negative image character such as a dead leaf may be displayed.

The first image data 50c is image data of a video image (first image) displayed in real time during the user performance, and is generated by arranging character data 50b corresponding to the analysis result of the performance data 50a at appropriate timings, for example. The second image data 50d is image data of a still image (second image) displayed after the performance is finished, for example.

In this embodiment, the program 41 includes a music analysis routine 41a, a performance technique detection routine 70b, an image creation routine 41c, and an output control routine 41d.

The music analysis routine 41a analyzes the input performance data 50a and acquires the tonality, chord, beat, time signature, etc., of the song that has been played or is being played. Even if the performance data 50a does not include the note name information itself or the chord specifying information, the note name can be acquired from note number information, and the chord specifying information can be acquired from a group of note names, for example. The procedure for determining tonality, code type, etc., is not particularly limited, but for example, the technique disclosed in Japanese Patent No. 3211839 can be used.

Further, the music analysis routine 41a analyzes the performance data 50a and causes the control unit 36 to extract the time-series features from the played sequence of notes. That is, the music analysis routine 41a analyzes the performance data 50a and extracts the time-series features of the sequence of notes.

The performance technique detection routine 41b detects the performance technique from the features extracted by the music analysis routine 41a. For example, suppose that the pitches of the notes arranged in chronological order change smoothly (for example, semitones or whole tones), and the time interval between the notes is very short. In this case, it can be determined that the “glissando” technique is played. It can also be determined whether the series of notes are arranged from high to low, or vice versa, and thereby the direction of the glissando can be determined from the result.

The image creation routine 41c creates the first image data 50c and the second image data 50d based on the performance data 50a by using, for example, the technique disclosed in Patent Document 1. Further, the image creation routine 41c creates the first image data 50c that reflects the performance technique detected by the performance technique detection routine 41b. That is, the image creation routine 41c causes the performance technique to be reflected on the real-time video image. As a result, the detected performance technique is also reflected in the still image after the performance is completed.

The output control routine 41d outputs the image data generated by the image creation routine 41c to the display unit 32 as a display device for displaying it.

Next, the operation of the above configuration will be described. Hereinafter, it is assumed that the information processing device 3 is communicably connected to the digital keyboard 1. Further, it is assumed that an application for displaying an image on the display unit 32 has been launched by the information processing device 3.

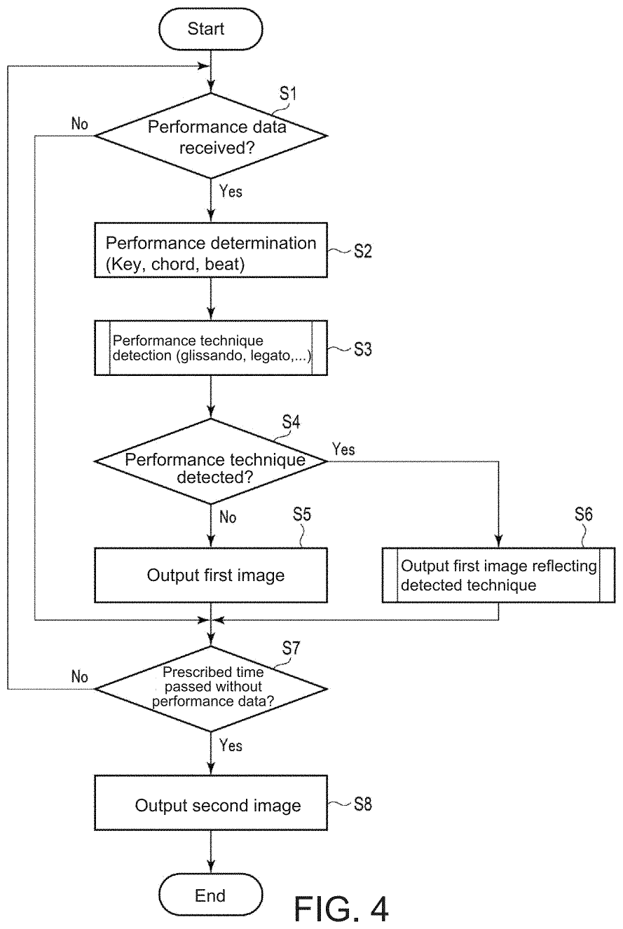

FIG. 4 is a flowchart showing an example of the processing procedure of the information processing device 3. In FIG. 4, the control unit 36 (CPU) of the information processing device 3 waits for the transmission of performance data from the digital keyboard 1 (step S1). Here, if there is no input of performance data (No in step S1), the control unit 36 determines whether or not a predetermined time has elapsed without performance data (step S7). If No in step S7, the processing procedure returns to step S1 again.

If the performance data is input in step S1 (Yes in step S1), the control unit 36 executes a performance determination process (step S2). In step S2, the control unit 36 determines, for example, the key of the song being played (for example, 24 types from C major to B minor), the chord type (for example, major, minor, sus4, aug, dim, 7^{th}, etc.), the beat, and the like based on the acquired performance data. The determination result obtained here is reflected in the first image.

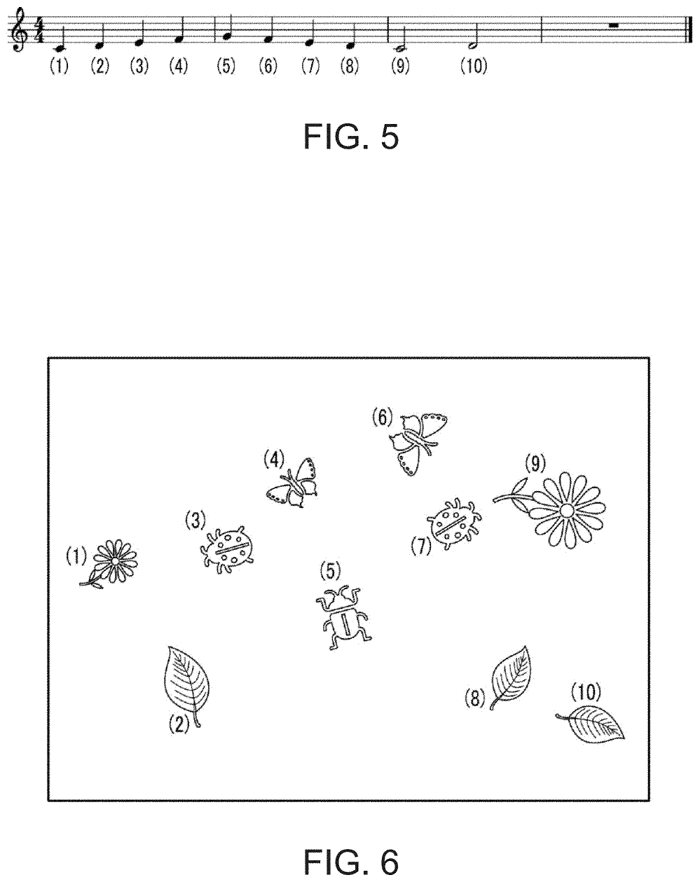

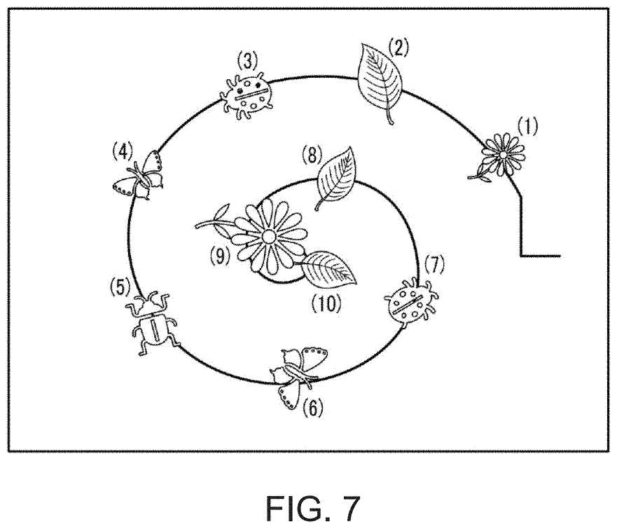

FIG. 5 is a diagram showing one musical score example. For example, when a performance as shown in FIG. 5 is performed, as shown in FIG. 6, the characters of flowers (1), leaves (2), ladybugs (3), and butterflies (4) appear one after another in the order of Do Re Mi, Fa, . . . , thereby forming the first image. When the performance is finished, each character is arranged on a spiral orbit as shown in FIG. 7, and becomes the second image.

Returning to FIG. 4, the explanation will be continued. Next, the control unit 36 performs a performance technique detection process (step S3). If the performance technique is not recognized (i.e., not detected) (No in step S4), the control unit 36 generates and outputs a first image according to the determination result that has been obtained before that time (step S5). On the other hand, if the performance technique is recognized (i.e., detected) (Yes in step S4), the control unit 36 generates and outputs a first image reflecting the detected performance technique (step S6). The processes of steps S3 and S6 will be described in more detail later.

During the user performance, the processes of steps S1 to S7 are repeated, and when the performance is finished, the result is Yes in step S7, the second image is generated and output, and the series of processes is completed.

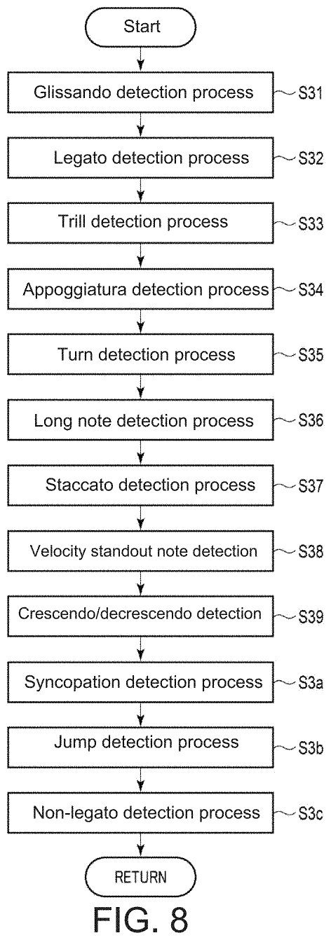

FIG. 8 is a flowchart showing an example of the processing procedure of the performance technique recognition (detection) process in step S3. In the performance technique detection process, for example, glissando detection process (step S31), legato detection process (step S32), trill detection process (step S33), appoggiatura detection process (step S34), turn detection process (step S35), long note detection process (step S36), staccato detection process (step S37), velocity standout note detection process (step S38), crescendo/decrescendo detection process (step S39), syncopation detection process (step S3a), jump detection process (step S3b), and non-legato detection process (step S3c) are executed. That is, each time the performance technique detection process is called, it is determined in steps S31 to S3c whether or not the performance input in real time corresponds to the respective performance techniques.

In the embodiment, the term “performance technique” is nearly synonymous with “performance expression” and is used in a broad interpretive sense. That is, all of the performance expressions shown in FIG. 8 will be described as “performance techniques”.

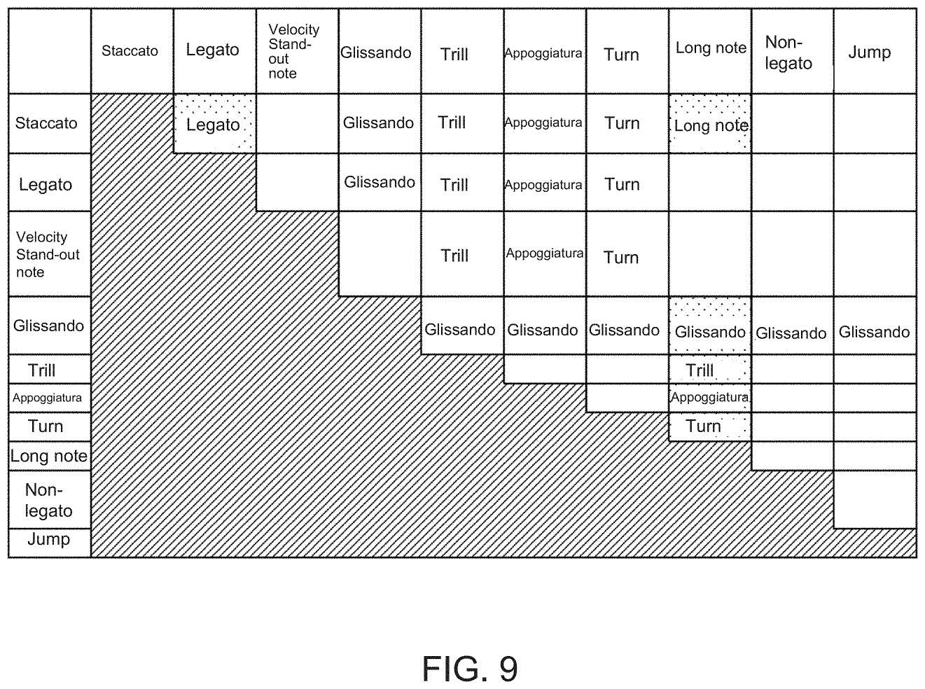

FIG. 9 is a diagram showing an example of setting which one is prioritized when a plurality of performance techniques are detected. For example, legato and staccato are not detected at the same time (indicated by dot hatching in the figure), but glissando and staccato may be detected at the same time. In such a case, for example, it is preferable to set in advance to preferentially select the glissando and register it in the table as shown in FIG. 9. Here, although not specifically depicted in FIG. 9, each of the blank boxes is actually either dot-hatched (no simultaneous detection) or is assigned a particular priority.

In addition, according to FIG. 9, if trill and glissando are detected, glissando is prioritized. Glissando is also prioritized between non-legato and glissando. Of course, this is only one example, and which one is prioritized can be freely changed at the time of shipment from the factory or by the user's setting. For example, for a performer who is good at glissando and uses it a lot, the glissando may be set to be prioritized more.

FIG. 9 also shows that long note and staccato are not detected at the same time, and that long note and any of glissando, trill, appoggiatura, and turn are not detected at the same time. In this way, by registering in advance a technique that will not be detected at the same time, there is an effect of shortening the process time. That is, for example, the remaining procedure of FIG. 8 may be skipped when glissando is detected and the process immediately may return to step S4 (FIG. 4) so that the time required for processing can be shortened. The table of FIG. 9 is stored in advance in the ROM 40 or RAM 50 of the memory 35 (FIG. 3).

<Glissando>

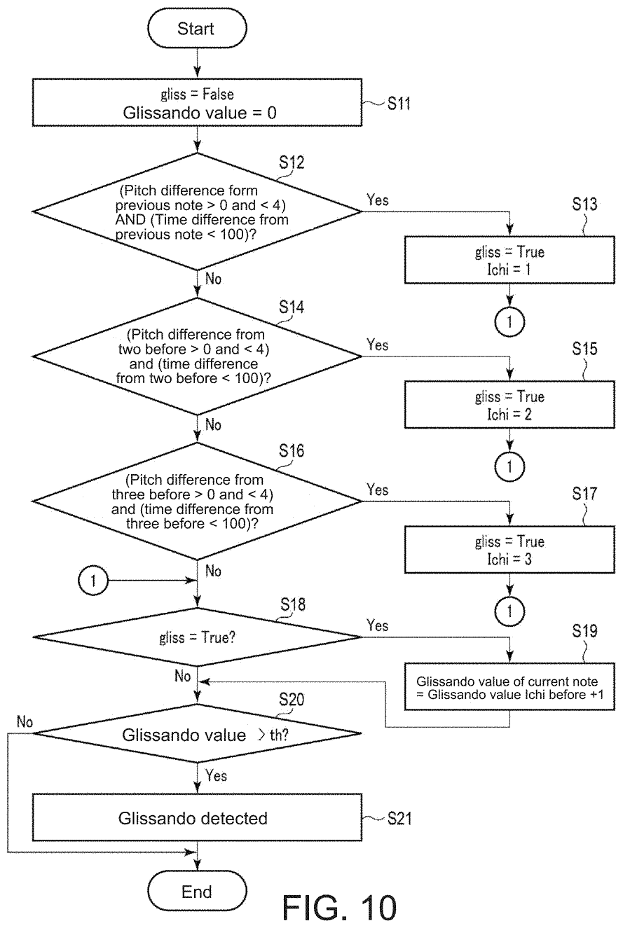

FIG. 10 is a flowchart showing an example of the processing procedure in the glissando detection process (step S31). In FIG. 10, the control unit 36 assigns False to the flag variable gliss and 0 to the glissando value of the current note, which is a variable, for initialization (step S11). The current note is a note that is currently attracting attention, that is, a note that is being produced evaluated at that time.

Next, the control unit 36 determines whether the Boolean expression ((0<(the pitch difference between the current note and the previous note)<4)Λ(the time difference between the current note and the previous note<100)) is True or False (step S12). Here, the pitch difference is (the pitch of the current note)−(the pitch of the previous note), Λ means the logical product (AND), and the unit of the time difference is Tick. If True (Yes in step S12), the control unit 36 assigns True to gliss, 1 to the variable Ichi representing the pitch interval, and jumps to step S18 (step S13).

If step S12 is False (No), the same determination is made with respect to the note two notes before the current note. That is, the control unit 36 determines whether ((0<(the pitch difference between the current note and the note two before it)<4)Λ(the time difference between the current note and the note two before it<100)) is True or False (step S14). If True (Yes), the control unit 36 assigns True to gliss, 2 to the variable Ichi, and jumps to step S18 (step S15).

If step S14 is also False (No), the same determination is made for the note three before the current note. That is, the control unit 36 determines whether or not ((0<(the pitch difference between the current note and the note three before it)<4)Λ(the time difference between the current note and the note three before it<100)) is True or False (step S16). If True (Yes), the control unit 36 assigns True to gliss, assigns 3 to the variable Ichi, and jumps to step S18 (step S17).

In step S18, the control unit 36 determines whether the flag variable gliss is True or False. If Yes, that is, gliss==True in step S18, the control unit 36 sets the glissando value of the current note to the glissando value of the Ichi number of notes before +1 (step S19). That is, the glissando value of the current note is a value indicating how many notes have been connected. If the determination result in step S18 is False (No), the glissando value of the current note is 0.

The reason for determining up to three previous notes in steps S12 to S16 is as follows. Because a keyboard instrument such as a piano is usually played with both hands, a chord or a single note melody may be played with the left hand, and a glissando may be played with the right hand at the same time. If the current note is the second or subsequent note of the right hand glissando and if the previous note is the note played with the left hand, the pitch difference would be 4 or more, the glissando value would not be increased even though the right hand is actually playing the glissando. Therefore, not only the note one before but also the notes up to three notes before are evaluated. In the other performance technique detection processes described below, performance data in which left-hand and right-hand performances are mixed is contemplated.

Next, the control unit 36 determines whether or not the glissando value of the current note is equal to or higher than the predetermined threshold value th (for example, 5) (step S20), and if Yes, it determines that the glissando has been played. (Step S21).

With the above procedure, an ascending glissando can be detected. An ascending glissando is a glissando from a lower pitch to a higher pitch. On the other hand, in order to determine the descending glissando, the pitch difference can be calculated by (the pitch of the previous note—the pitch of the later note) in steps S12, S14, and S16.

In the above procedure, the music analysis routine 41a analyzes the performance data 50a and extracts the pitch difference between the played notes and the time interval between the notes. Then, the performance technique detection routine 41b detects the glissando when the extracted pitch difference is less than the default value and the time interval is less than the default threshold value.

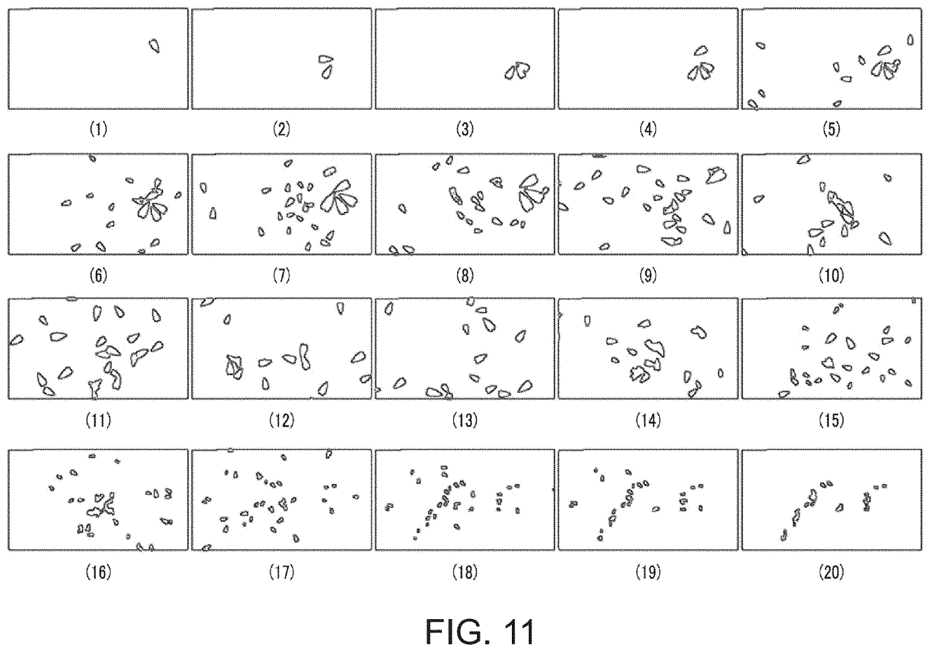

FIG. 11 is a diagram showing an example of expression when glissando is detected. This figure shows each frame of a continuous image arranged frame by frame. In FIG. 11, when the line of sight is moved quickly in the order of the numbers (1) to (20), it can be seen that the petals are scattered around the center of the screen. The feeling of running through the glissando is expressed by the petals fluttering. For high-to-low glissandos, the petals may be fluttering from right to left, and for low-to-high glissandos, the petals may be fluttering from left to right.

<Legato>

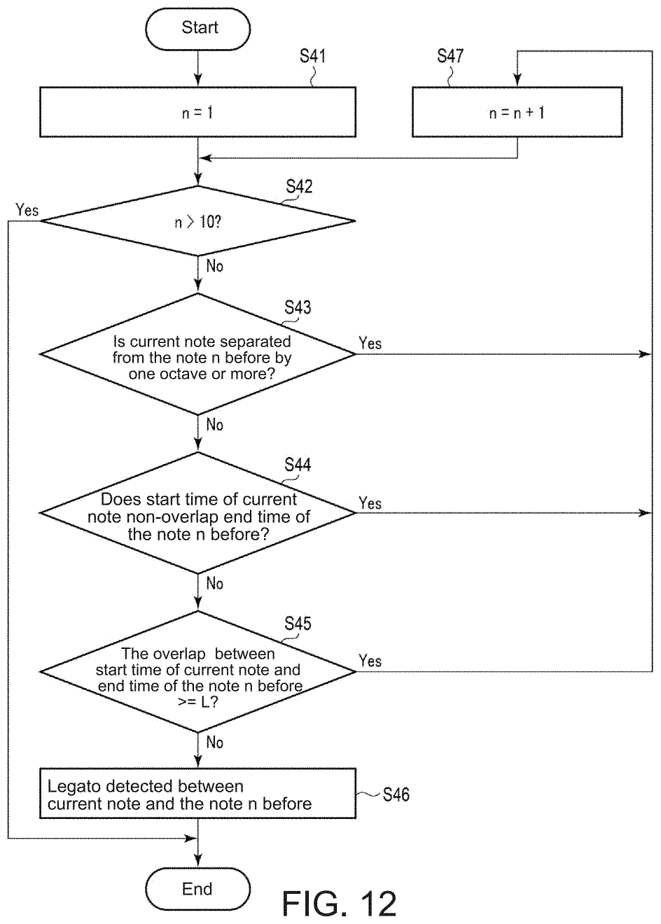

FIG. 12 is a flowchart showing an example of the processing procedure in the legato detection process (step S32). In FIG. 12, the control unit 36 assigns 1 to the variable n indicating the number of notes that goes back in the past in time series from the current note for initialization (step S41), and determines whether or not the variable n reaches 10 immediately after entering the loop (step S42). If n is more than 10, the process ends, but if N is 10 or less, the control unit 36 determines whether or not the current note and the note n before are separated by one octave or more (step S43). If Yes in step S43, the control unit 36 increments n by 1 (step S47), and the processing procedure returns to step S42.

If No in step S43, the control unit 36 determines whether the start time of the current note and the end time of the note n before do not overlap (step S44). If they do not overlap (non-overlap; Yes), the sound is cut off, the control unit 36 increments n by 1 (step S47), and the processing procedure returns to step S42.

If No in step S44, these notes overlap. Therefore, the control unit 36 determines whether or not the length of the period in which the start time of the current note and the end time of the note n before overlap is equal to or greater than the default threshold value L (step S45). If Yes in step S45, the control unit 36 increments n by 1 (step S47), and the processing procedure returns to step S42. If No in step S45, the control unit 46 determines that legato playing is detected, and sets the relationship between the note n before and the current note as the legato (step S46).

In the above procedure, the music analysis routine 41a analyzes the performance data 50a and if a second note is played during the time in which the sound of a first note is being produced, extracts the period during which the first note and the second note are sound-produced simultaneously. Then, the performance technique detection routine 41b detects the legato when that simultaneous sound production period is less than a predetermined threshold value.

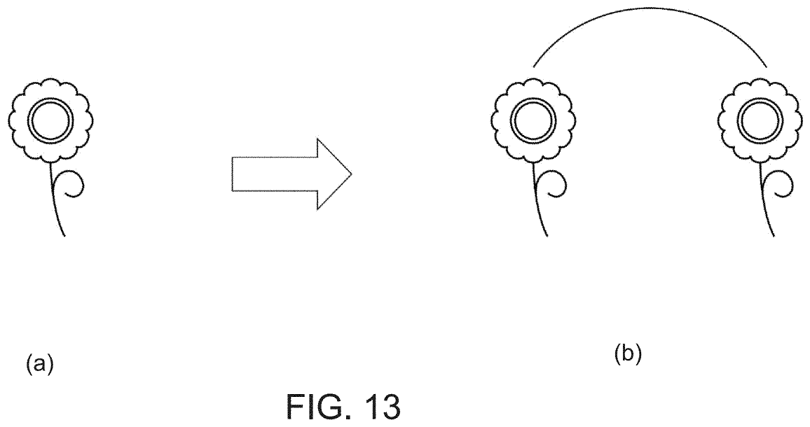

FIG. 13 is a diagram showing an example of an image expression when legato is detected. The image (a) shows that a played note is expressed by a flower character in the image. When a second note is played subsequently with legato relative to the first note, the second note is expressed by another flower character connected to the first note by a slur-like bow-shaped character, as shown in the image (b). For example, if the connecting character is a rainbow-like character, the resulting image becomes aesthetic and artistic. A design that thins the rainbow for a weak-sounding legato and thickens the rainbow for a strong-sounding legato is also effective.

<Trill>

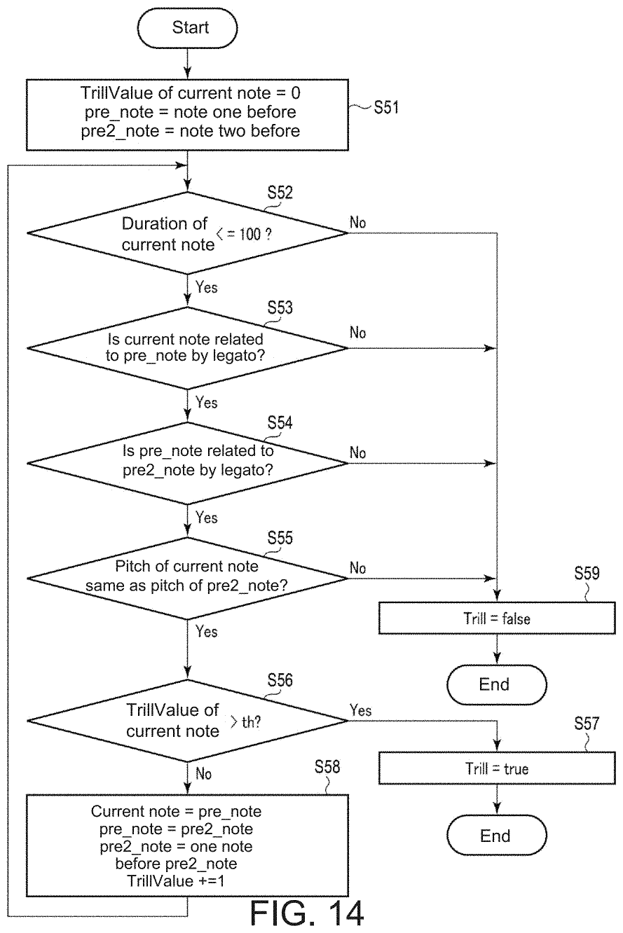

FIG. 14 is a flowchart showing an example of the processing procedure in the trill detection process (step S33). In FIG. 14, the control unit 36 assigns 0 to the variable, TrillValue, of the current note for initialization (step S51). The current note is a note that is currently attracting attention, that is, a note that is being sound-produced and evaluated at that time. Further, the note one before the current note is represented as pre_note, and the note two before the current note is represented as pre2_note.

Next, the control unit 36 determines whether (the duration (Gate Time) of the current note≤100) is satisfied (step S52), and if Yes, the control unit 356 determines whether the current note and the note one before (pre_note) are have a legato relationship (step S53). If Yes, the control unit 36 further determines whether the pre_note and the note two before, that is, pre2_note, have a legato relationship (step S54). If Yes, the control unit 36 further determines whether the pitch of the current note and the pitch of pre2_note are the same or not (step S55). If the pitch of the current note and the pitch of pre2_note are the same in step S55 (Yes), the control unit 36 determines whether or not the TrillValue of the current note is larger than the default threshold value th (step S56).

If Yes in step S56, the control unit 36 determines that the instrument is being played in a trill (step S57), assigns True to the flag variable Trill, and exits the trill detection process. On the other hand, if No in step S56, the control unit 36 assigns pre_note to the current note (current note=pre_note), pre2_note to pre_note (pre_note=pre2_note), and the note one before pre2_note to pre_2note (pre2_note=one note before pre2_note), and TrillValue is incremented by 1 (step S58). Then, the processing procedure returns to step S52. If No in steps S52, S53, S54, and S55, the control unit 36 set False to the flag variable Trill, determines that there is no trill (step S59), and exits the trill detection process.

In the above procedure, the music analysis routine 41a analyzes the performance data 50a to extract, with respect to a first note the duration of which is equal to or less than a prescribed threshold (the current note), a first simultaneous sound generation period, which is a time period during which the first note and the note one before (second note; pre_note) are simultaneously sound-produced, as well as a second simultaneous sound generation period, which is a time period during which the second note (pre_note) and the note two before the first note (third note; pre2_note) are simultaneously sound-produced. Then, the performance technique detection routine 41b determines that a trill is performed if the first sound generation period and the second sound generation period are both shorter than a prescribed threshold value and the pitch of the current note and the pitch of the pre2_note are the same.

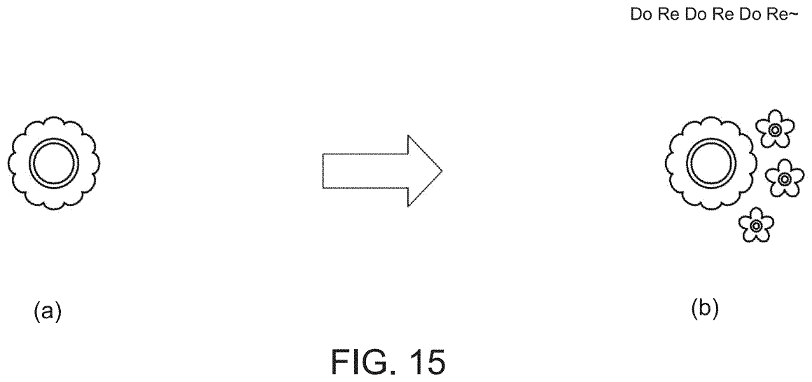

FIG. 15 is a diagram showing an example of an image expression when a trill is detected. For example, when a trill is played with a pitch difference of Do Re Do Re Do Re˜, small characters such as the image (b) appear one after another around the character in the image (a) so as to express the effect of decorating the primary note. Changing the number of decorations (the number of small characters) according to the length of the trill makes the expression even more effective.

<Velocity Standout Note>

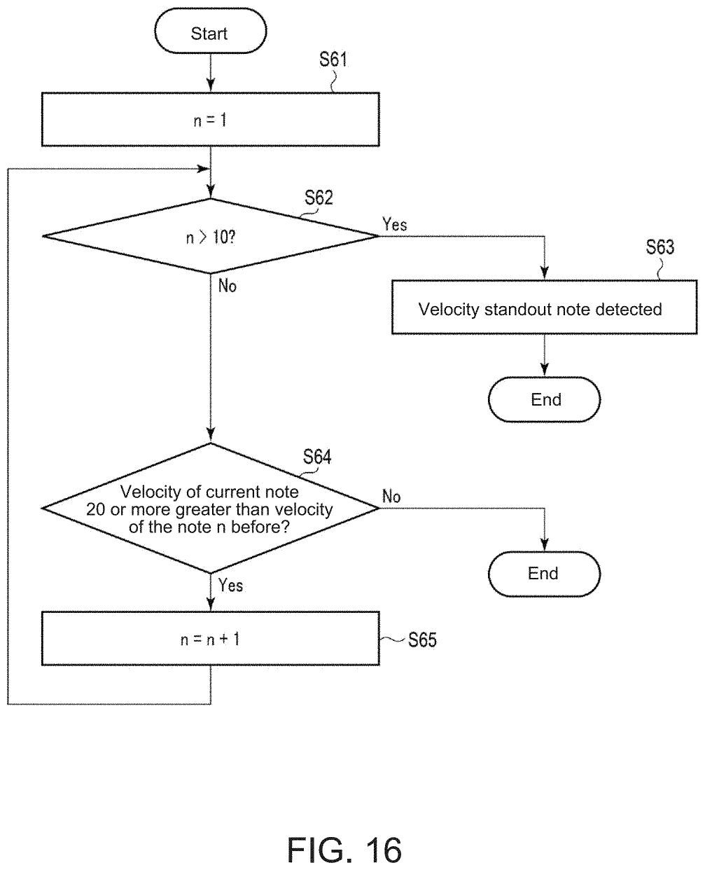

FIG. 16 is a flowchart showing an example of the processing procedure in the velocity standout note detection process (step S38). In FIG. 16, the control unit 36 assigns 1 to the variable n indicating the number of notes to go back in the past in time sequence from the current note for initialization (step S61), and determines whether or not the variable n becomes greater than 10 immediately after entering the loop (step S62). If n exceeds 10, the control unit 36 determines that a velocity standout note is detected (step S63). That is, it is determined that a loud sound is suddenly played.

If n is 10 or less, the control unit 36 determines whether or not the velocity of the current note is a threshold value, 20 or more, for example, higher than that of the note n before (step S64). If No in step S64, the process ends, but if Yes, the control unit 36 increments n by 1 (step S65), and the process returns to step S62.

In the above procedure, the music analysis routine 41a extracts the velocity difference obtained by subtracting the velocity of a first note from a velocity of the second note that was played prior to the first note. Then, the performance technique detection routine 41b determines that a velocity standout note is detected when the extracted velocity difference is equal to or more than a prescribed threshold value.

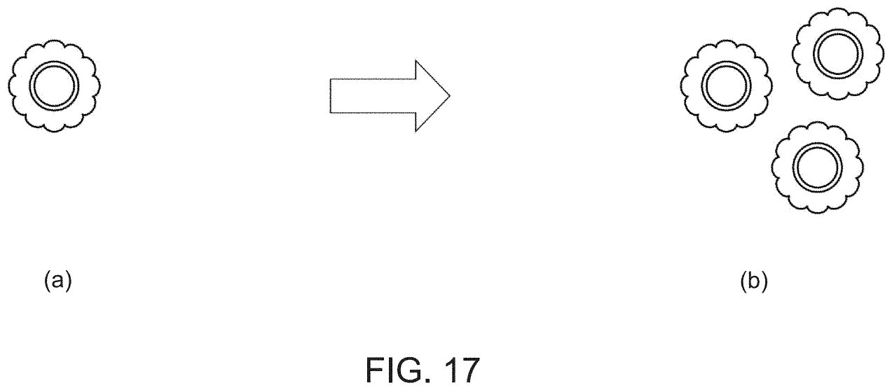

FIG. 17 is a diagram showing an example of an image expression when a velocity standout note is detected. For example, when a velocity standout note is detected for the note that would otherwise be represented by the character of the image (a), a plurality of the same characters of the same size are displayed as shown in the image (b). The number of characters may be changed according to the value of the velocity difference.

In the above, the determination methods for some of the performance techniques have been concretely illustrated. A person skilled in the art who understands the procedures of these examples can easily realize and implement performance technique determination procedures for the other performance techniques from the time-series characteristics of the sequence of notes played by the user performance.

As described above, in these embodiments, the performance data generated by the user performance is analyzed, and the time-series characteristics of the sequence of notes played are extracted. Then, the playing technique was judged and recognized based on the extracted characteristics. Furthermore, a video image (first image) reflecting the detected playing technique is generated and displayed in real time. By doing so, it becomes possible to generate and draw a visual expression corresponding to the playing technique in real time, and it becomes possible to further enhance the enjoyment of visually expressing the music performance.

According to the embodiments, it becomes possible to reflect the performance technique in the video expression and visualize the music with a richer expression. This makes it possible to provide programs, methods, information processing devices, and performance data display systems that promote the enjoyment of playing and the motivation to practice. That is, according to the present disclosure, since the playing technique can be reflected in the image expression, it is possible to further enhance the enjoyment of playing.

The present disclosure is not limited to the specific embodiments. In the embodiment above, a tablet-type mobile terminal, which is separate from the digital keyboard 1, is assumed as the information processing device 3. But the present invention is not limited to this. For example, instead of the tablet-type mobile terminal, a desktop computer or a notebook computer may be used. Alternatively, the digital keyboard 1 itself may have the functions of the information processing device.

Further, in the embodiments above, cases for glissando, legato, trill, and velocity standout note are described, but the present invention is not limited to these. That is, as shown in FIG. 8, it is possible to recognize and detect appoggiatura, turns, long notes, staccato, crescendo/decrescendo, jumps, and non-legato by extracting the relevant or corresponding time-series characteristics of the sequence of notes. Furthermore, syncopation, which is a rhythm expression, can be recognized based on the knowledge of beats, time signatures, etc., acquired by music analysis, and it is possible to draw a image expression that matches each of these performance techniques.

In addition, the technical scope of the present disclosure includes various modifications and improvements to the extent that the object of the present disclosure is achieved, which is apparent to those skilled in the art from the description of the scope of claims.

It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. A method performed by one or more processors in an information processing device for an electronic musical instrument, the method comprising, via the one or more processors:
receiving performance data generated by a user performance of the electronic musical instrument;
extracting time-series characteristics of a sequence of notes from the performance data;
detecting a performance technique from the extracted characteristics; and
generating an image data reflecting the detected performance technique and outputting the generated image data.

2. The method according to claim 1,
wherein the extracting the time-series characteristics includes extracting a pitch difference and a time interval between notes in the sequence of notes, and
wherein the detecting the performance technique includes determining that a glissando is played when the extracted pitch difference is less than a prescribed value, and extracted time interval is less than a prescribed threshold.

3. The method according to claim 1,
wherein the extracting the time-series characteristics includes, when a second note is played during a time in which a first note is being played, extracting a simultaneous sound generation period during which the first and second notes are simultaneously sound-produced, and
wherein the detecting the performance technique includes determining that a legato is played when the extracted simultaneous sound generation period is less than a prescribed threshold.

4. The method according to claim 1,
wherein the extracting the time-series characteristics includes, with respect to a first note a duration of which is equal to or less than a prescribed threshold, extracting a first simultaneous sound generation period that is a time period during which the first note and a second note, which is a note one before the first note, are simultaneously sound-produced, as well as a second simultaneous sound generation period that is a time period during which the second note and a third note, which is a note two before, are simultaneously sound-produced, and
wherein the detecting the performance technique includes determining that a trill is played when the first sound generation period and the second sound generation period are both shorter than a prescribed threshold value and a pitch of the first note and a pitch of the third note are the same.

5. The method according to claim 1,
wherein the extracting the time-series characteristics includes extracting a velocity difference that is obtained by subtracting, from a velocity of a first note, a velocity of a second note that is played prior to the first note, and
wherein the detecting the performance technique includes determining that a velocity standout note is played when the extracted velocity difference is equal to or greater than a prescribed threshold.

6. The method according to claim 1, wherein the detecting the performance technique includes attempting to detect a plurality of performance techniques and if plural performance techniques out of the plurality of performance techniques are detected, referring to a lookup table that specifies priorities among the plurality of performance techniques so as to select one of the detected plural performance techniques as said performance technique detected.

7. The method according to claim 6, wherein the plurality of performance techniques includes two or more of glissando, legato, trill, appoggiatura, turn, long note, staccato, velocity standout note, crescendo/decrescendo, syncopation, jump, and non-legato.

8. An information processing device for an electronic musical instrument, comprising: one or more processors, configured to perform the following:
receiving performance data generated by a user performance of the electronic musical instrument;
extracting time-series characteristics of a sequence of notes from the performance data;
detecting a performance technique from the extracted characteristics; and
generating an image data reflecting the detected performance technique and outputting the generated image data to an display device for display.

9. The information processing device according to claim 8,
wherein the extracting the time-series characteristics includes extracting a pitch difference and a time interval between notes in the sequence of notes, and
wherein the detecting the performance technique includes determining that a glissando is played when the extracted pitch difference is less than a prescribed value, and extracted time interval is less than a prescribed threshold.

10. The information processing device according to claim 8,
wherein the extracting the time-series characteristics includes, when a second note is played during a time in which a first note is being played, extracting a simultaneous sound generation period during which the first and second notes are simultaneously sound-produced, and
wherein the detecting the performance technique includes determining that a legato is played when the extracted simultaneous sound generation period is less than a prescribed threshold.

11. The information processing device according to claim 8,
wherein the extracting the time-series characteristics includes, with respect to a first note a duration of which is equal to or less than a prescribed threshold, extracting a first simultaneous sound generation period that is a time period during which the first note and a second note, which is a note one before the first note, are simultaneously sound-produced, as well as a second simultaneous sound generation period that is a time period during which the second note and a third note, which is a note two before, are simultaneously sound-produced, and
wherein the detecting the performance technique includes determining that a trill is played when the first sound generation period and the second sound generation period are both shorter than a prescribed threshold value and a pitch of the first note and a pitch of the third note are the same.

12. The information processing device according to claim 8,
wherein the extracting the time-series characteristics includes extracting a velocity difference that is obtained by subtracting, from a velocity of a first note, a velocity of a second note that is played prior to the first note, and
wherein the detecting the performance technique includes determining that a velocity standout note is played when the extracted velocity difference is equal to or greater than a prescribed threshold.

13. The information processing device according to claim 8, wherein the detecting the performance technique includes attempting to detect a plurality of performance techniques and if plural performance techniques out of the plurality of performance techniques are detected, referring to a lookup table that specifies priorities among the plurality of performance techniques so as to select one of the detected plural performance techniques as said performance technique detected.

14. The information processing device according to claim 13, wherein the plurality of performance techniques includes two or more of glissando, legato, trill, appoggiatura, turn, long note, staccato, velocity standout note, crescendo/decrescendo, syncopation, jump, and non-legato.

15. An performance data display system, comprising:
the information processing device as set forth in claim 8;
the electronic musical instrument, as recited in claim 8; and
the display device, as recited in claim 8.

16. A non-transitory computer readable storage medium storing a software program to be read by one or more of processors in an information processing device for an electronic musical instrument, the software program causing the one or more processors to perform the following:
receiving performance data generated by a user performance of the electronic musical instrument;
extracting time-series characteristics of a sequence of notes from the performance data;
detecting a performance technique from the extracted characteristics; and
generating an image data reflecting the detected performance technique and outputting the generated image data.

17. The non-transitory computer readable storage medium according to claim 16, wherein the detecting the performance technique includes attempting to detect a plurality of performance techniques and if plural performance techniques out of the plurality of performance techniques are detected, referring to a lookup table that specifies priorities among the plurality of performance techniques so as to select one of the detected plural performance techniques as said performance technique detected.

18. The non-transitory computer readable storage medium according to claim 17, wherein the plurality of performance techniques includes two or more of glissando, legato, trill, appoggiatura, turn, long note, staccato, velocity standout note, crescendo/decrescendo, syncopation, jump, and non-legato.
